(19) United States
(12) Patent Application Publication
(10) Pub. No.: US 2008/0145652 A1
(43) Pub. Date: Jun. 19, 2008

(54) Multilayer Film Based on a Fluoropolymer and an Acrylic Polymer

(75) Inventors: Anthony Bonnet, Beaumont Le Roger (FR); Sandrine Duc, Paris (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 11/816,479

(22) PCT Filed: Feb. 21, 2006
(86) PCT No.: PCT/EP2006/002196

§ 371 Date: Aug. 16, 2007

Related U.S. Application Data
(60) Provisional application No. 60/668,915, filed on Apr. 6, 2005.

(30) Foreign Application Priority Data
Feb. 23, 2005 (FR) 0501831

(51) Int. Cl. B32B 5/00

(52) U.S. Cl. 428/336

(57) ABSTRACT

The invention relates to the use of a multilayer film for protecting a substrate which gives off volatile compounds which comprises: a surface layer comprising, by weight, from 70 to 100%, preferably from 90 to 100%, of a fluoropolymer and from 0 to 30%, preferably from 0 to 10% of an acrylic polymer; an adhesive layer comprising from 50 to 100% of an acrylic polymer, from 0 to 50% of a fluoropolymer, from 1 to 10% of a UV stabilizer and from 0 to 50% of an impact modifier, characterized in that the thickness of the surface layer is between 2 and 15 μm, preferably between 2 and 10 μm, more preferably still between 3 and 8 μm, and the thickness of the adhesive layer is between 30 and 75 μm, preferably between 30 and 60 μm, more preferably still between 30 and 50 μm. The invention also relates to a substrate protected by the multilayer film.

### FIELD OF THE INVENTION

The present invention relates to the use of a multilayer film based on a fluoropolymer and on an acrylic polymer for protecting a substrate which makes it possible to prevent the trapping of volatile compounds by the multilayer film. In particular, it relates to the case where the substrate is a thermo-plastic material, in particular a PVC or ABS profile, or a thermoset material, in particular an unsaturated polyester or a cellulose or lignocellulose material impregnated with an adhesive. In particular, it relates to the case where the substrate is a sandwich panel.

Due to their very good resistance to bad weather, to radiation and to chemicals, films made of fluoropolymer (in particular of poly(vinylidene fluoride), PVDF) are used to protect objects or materials. The materials can be various; they can in particular be thermoplastic materials or thermoset materials. However, films made of fluoropolymer exhibit a fairly low intrinsic adhesion, so that it is often necessary to apply, between the film and the substrate to be protected, an adhesive composition which is composed of an acrylic polymer or of a blend of acrylic polymer and of fluoropolymer. This composition is coextruded with the fluoropolymer to form a two-layer film and then this film is subsequently attached to the substrate, for example by hot pressing. It is also possible to place the two-layer film in a mould, the layer of fluoropolymer being placed against the wall of the mould, to then inject the precursor of the thermoset material into the mould and subsequently to bring about crosslinking in order to obtain a PVDF-coated thermoset material.

To prevent delamination of the multilayer film, it is necessary for the adhesive composition to retain good thermomechanical behaviour and to maintain good adhesion under operating conditions where the film and the substrate are mechanically stressed, even at a temperature of greater than 40° C.

In addition, the multilayer film must retain an alternative surface appearance once applied to the substrate. It must therefore completely cover the substrate without there being defects at the interface between the film and the substrate. Thus, in the case of PVC or of ABS, in particular PVC profiles, a chlorinated solvent (for example trichloroacetate) is sometimes applied in order to clean the surface. A portion of the solvent may remain trapped in the material and may then slowly degas once the multilayer film has been applied. In the case of the protection of thermoset materials, for example unsaturated polyester resins or phenolic resins, the formation of the thermoset material is carried out under hot conditions and is often accompanied by the release of volatile compounds. For example, in the case of an unsaturated polyester resin, an unsaturated polyester is diluted in a monomer possessing ethylenic unsaturation to adjust the viscosity of the mixture. The monomer acts both as solvent for the polyester and as crosslinking (or curing) agent. The monomer possessing ethylenic unsaturation is capable of being released when the resin is heated. Another example in the case of a thermoset material is that of phenolic resins, which release water during the formation under hot conditions of the resin.

Finally, mention may be made of the case of the protection of cellulose materials (for example made of wood, chipboard or made of paper, and the like) impregnated beforehand with an adhesive capable of releasing volatile compounds (for example, an adhesive of hot melt type or an adhesive in dispersion or in solution in water).

The Applicant Company has found that the multilayer film of the invention as defined in claim 1 makes it possible to efficiently protect the substrate which it covers, without exhibiting delamination and while avoiding the problem of trapping of volatile compounds.

### THE PRIOR ART AND THE TECHNICAL PROBLEM

Patent U.S. Pat. No. 4,226,904 discloses the coating of a PMMA sheet with a multilayer PVDF film, the thickness of which is at most one tenth of the thickness of the sheet.

Patent U.S. Pat. No. 4,317,860 discloses the coating of thermo-plastic materials, such as ABS or PVC, with a two-layer PVDF/PMMA film. The thickness of the PVDF layer varies from 10 μm to a few hundred μm. That of the PMMA layer varies from a few μm to 200 μm. The thicknesses of the PVDF layers in the examples are of the order of 75-100 μm.

Patent U.S. Pat. No. 4,364,886 discloses a substrate made of ABS or of thermoset material based on unsaturated polyester covered with a PVDF film; an adhesive is placed between the PVDF and the substrate. This adhesive is either PMMA or a blend, by weight, of 30% of PMMA, of 40% of an acrylic elastomer, of 25% of ABS and of 5% of a mixture of zinc oxide and of zinc sulphide. The thicknesses of the PVDF layers in the examples are of the order of 75-100 μm.

Patent U.S. Pat. No. 5,242,976 discloses a composition coextrudable with PVDF in order to make it adhere to substrates. The composition is a blend, by weight, of 27 to 50% of PMMA, of 17.5 to 36.5% of PVDF and of 25 to 47.45% of an acrylic elastomer. In all these prior arts above, no mention is made of UV stabilizers in the adhesive composition.

Patent U.S. Pat. No. 4,364,886 discloses a substrate made of ABS or of unsaturated polyester covered with a PVDF film; an adhesive is placed between the PVDF and the substrate. This adhesive is a blend, by weight, of 30% of PMMA, of 40% of an acrylic elastomer and of 30% of ABS.

Patent U.S. Pat. No. 4,415,519 discloses a substrate made of ABS or of PVC covered with a PVDF film; an adhesive is placed between the PVDF and the substrate. This adhesive can be either PMMA or a blend, by weight, of 40% of PMMA, of 30% of PVDF and of 30% of ABS or a blend, by weight, of 30% of PMMA, of 40% of a poly-acrylic derivative and of 30% of ABS. The thickness of the PVDF layer varies from 10 μm to a few hundred μm.

That of the PMMA layer varies from a few μm to 200 μm. The thicknesses of the PVDF layers in the examples are of the order of 75-100 μm.

Patent EP 733 475 B1 discloses substrates coated with PVDF; the structure successively comprises the substrate, an adhesive layer, a PVDF layer rendered opaque to UV radiation and to visible radiation and a PVDF layer. The opaque PVDF layer is obtained by adding, to the PVDF, a product chosen from metal oxides, pigments and benzophenones. The examples illustrate only PVDF charged with 15% by weight of zinc oxide. The thicknesses of the layers range from 10 to 200-300 μm. In the examples, the thicknesses are of the order of 50-100 μm.

Application EP 1 388 414 discloses the use of a single-layer PMMA film or of a two-layer PMMA/PVDF film for coating a multilayer board, the film being applied against a layer on which a phenolic resin has been deposited. The thicknesses of the two layers of the PMMA/PVDF film are not specified. It is not specified either that a UV stabilizer is present in the film.

Application EP 1 405 872 discloses a multilayer film based on PVDF, on PMMA or their blend for covering objects made of thermoset material. The adhesive layer has a thickness of between 10 and 100 μm and the outer layer has a thickness between 2 and 50 μm. The examples do not mention any specific thickness.

Application JP 680794 A1 of Kureha Chemical (published 22/03/1994) describes a multilayer film comprising a layer of PVDF and a layer of PMMA that can adhere on PVC but no mention is made the PVC releases any volatile compound.

Application JP 4202280 of Shinetsu Chemical (published 23/07/1997) describes a film comprising a mixture of PVDF and PMMA that can be laminated on a layer of hot-melt adhesive. It does not describe any surface layer based on a fluoropolymer.

In the literature, no composition or film mentions problems related to the release of volatile compounds which may be harmful to the surface appearance of the film.

### FIGURES

FIG. 1 represents, in transverse view, a multilayer film 1 according to the invention covering a plastic (PVC, ABS) profile 2.

FIG. 2 represents, in transverse view, a sandwich panel based on cellulose or lignocellulose material. The sandwich panel 3 comprises a base part made of kraft paper 6, the base part being impregnated with a phenolic resin, a layer of wood 5 and a layer of adhesive 4. The multilayer film 1 according to the invention is applied to the layer of adhesive 4.

FIG. 3 represents, in transverse view, a sandwich panel 7 based on cellulose or lignocellulose material which comprises a base part made of kraft paper 6, the base part being impregnated with a phenolic resin, two layers of wood 5 and 5′ and two layers of adhesive 4 and 4′. Two multilayer films 1 and 1′ according to the invention are applied to the layers of adhesive 4 and 4′ respectively.

FIG. 4 represents, in transverse view, a chipboard 8 covered with a multilayer film 1 according to the invention. The chipboard comprises compacted wood chips or fibres bonded to one another using an adhesive.

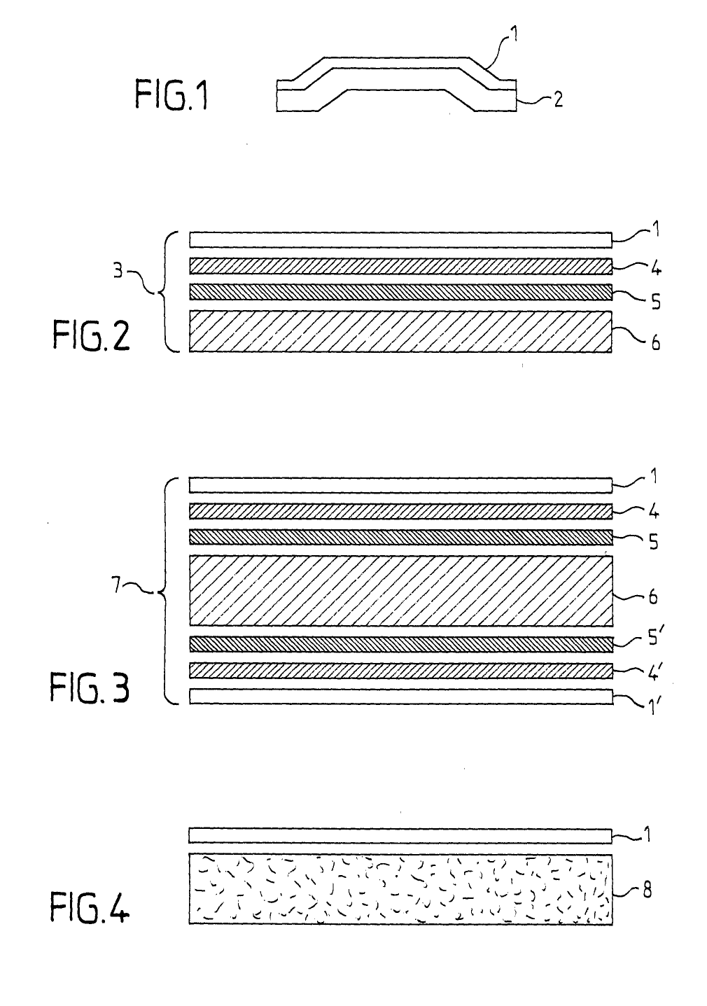

### BRIEF DESCRIPTION OF THE INVENTION

The invention relates to the use of a multilayer film for protecting a substrate which gives off volatile compounds which comprises:
a surface layer comprising, by weight, from 70 to 100%, preferably from 90 to 100%, of a fluoropolymer and from 0 to 30%, preferably from 0 to 10% of an acrylic polymer;
an adhesive layer comprising from 50 to 100% of an acrylic polymer, from 0 to 50% of a fluoropolymer, from 1 to 10% of a UV stabilizer and from 0 to 50% of an impact modifier,
   characterized in that the thickness of the surface layer is between 2 and 15 μm, preferably between 2 and 10 μm, more preferably still between 3 and 8 μm, and the thickness of the adhesive layer is between 30 and 75 μm, preferably between 30 and 60 μm, more preferably still between 30 and 50 μm.

The film can comprise a peelable protective layer placed on the side of the surface layer, that is to say on the side opposite the adhesive layer. This layer is peeled off after attaching the film to the substrate.

The multilayer film according to the invention exhibits good resistance to bad weather, to radiation, to chemicals and to scratching, despite a low thickness of the surface layer. Moreover, it exhibits good adhesion to the substrate to be protected, so that there is little tendency for it to delaminate. Finally, it makes it possible to avoid the formation of bubbles at the interface between the film and the substrate.

The substrate can be thermoplastic, such as a PVC or ABS profile, a thermoset material, such as an unsaturated polyester or a cellulose or lignocellulose material impregnated with an adhesive. In particular, it can be a sandwich panel.

The invention also relates to a multilayer structure comprising the substrate protected by the multilayer film.

### DETAILED DESCRIPTION OF THE INVENTION

As regards the fluoropolymer, this term is used to denote any polymer having, in its chain, at least one monomer chosen from compounds comprising a vinyl group capable of opening in order to polymerize and which comprises, directly attached to this vinyl group, at least one fluorine atom, one fluoroalkyl group or one fluoroalkoxy group.

Mention may be made, as examples of monomers, of vinyl fluoride; vinylidene fluoride (VDF of formula CH₂═CF₂); trifluoroethylene (VF₃); chlorotrifluoroethylene (CTFE); 1,2-difluoroethylene; tetrafluoroethylene (TFE); hexafluoropropylene (HFP); perfluoro(alkyl vinyl ether)s, such as perfluoro(methyl vinyl ether) (PMVE), perfluoro(ethyl vinyl ether) (PEVE) and perfluoro(propyl vinyl ether) (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n is 1, 2, 3, 4 or 5; the product of formula R₁CH₂OCF═CF₂ in which R₁ is hydrogen or F(CF₂) and z has the value 1, 2, 3 or 4; the product of formula R₃OCF═CH₂ in which R₃ is F(CF₂)ₙ— and z is 1, 2, 3 or 4; perfluorobutylethylene (PFBE); 3,3,3-tri-fluoropropene and 2-trifluoromethyl-3,3,3-trifluoro-1-propene. The fluoropolymer can be a homopolymer or a copolymer; it can also comprise nonfluorinated monomers, such as ethylene.

By way of examples, the fluoropolymer is chosen from:
vinylidene fluoride (VDF) homo- and copolymers preferably comprising at least 50% by weight of VDF, the comonomer being chosen from chlorotrifluoroethylene (CTFE), hexafluoro-propylene (HFP), trifluoroethylene (VF₃) and tetrafluoroethylene (TFE),
trifluoroethylene (VF₃) homo- and copolymers,
copolymers, and in particular terpolymers, combining the residues of the chlorotrifluoro-ethylene (CTFE), tetrafluoroethylene (TFE), hexafluoropropylene (HFP) and/or ethylene units and optionally of the VDF and/or VF₃ units.

Advantageously, the fluoropolymer is a poly(vinylidene fluoride) (PVDF) homopolymer or copolymer. Preferably, the fluoropolymer is a PVDF comprising, by weight, at least 50% of VDF, more preferably at least 75% and better still at least 85%. The comonomer which is advantageously combined with the VDF is HFP or CTFE.

Advantageously, the PVDF has a viscosity ranging from 100 Pa·s to 2000 Pa·s, the viscosity being measured at 230° C. at a shear gradient of 100 s⁻¹ using a capillary rheometer. This is because these PVDFs are well suited to extrusion and to injection moulding. Preferably, the PVDF has a viscosity ranging from 300 Pa·s to 1200 Pa·s, the viscosity being measured at 230° C. at a shear gradient of 100 s⁻¹ using a capillary rheometer. Thus, the PVDFs sold under the references Kynar® 710, 720 or 740 are perfectly suited to this formulation, as are the PVDFs sold under the references Kynarflex® 2802, 2800, 2850 or 3120.

As regards the acrylic polymer, this term is used to denote a methyl methacrylate homo- or copolymer comprising at least 50% by weight of methyl methacrylate. Mention may be made, as examples of comonomers, of alkyl (meth)acrylates, acrylonitrile, butadiene, styrene or isoprene. Examples of alkyl (meth)acrylates are described in Kirk-Othmer, Encyclopedia of Chemical Technology, 4th edition, in volume 1, on pages 292-293, and in volume 16, on pages 475-478.

Advantageously, the acrylic polymer can comprise, by weight, from 0 to 20%, preferably from 5 to 15%, of at least one other alkyl (meth)acrylate chosen from methyl acrylate, ethyl (meth)acrylate, butyl (meth)acrylate and/or 2-ethylhexyl (meth)acrylate.

In order to promote the adhesion with the substrate of between the surface layer and the adhesive layer, the acrylic polymer can be functionalized, that is to say that it comprises monomers carrying acid, acid chloride, alcohol, anhydride or ureido functional groups. These functional groups can be introduced by grafting in an extruder or in solution or better still by copolymerization with the methyl methacrylate. As regards the acid functional groups, this is advantageously an acid functional group introduced by the acrylic or methacrylic acid comonomer. Two neighbouring acid functional groups can dehydrate to form an anhydride functional group according to the following formula, in which m has the value 0 or 1.

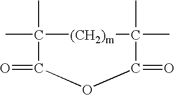

As regards the ureido functional group, it can be introduced by the following methacrylate:

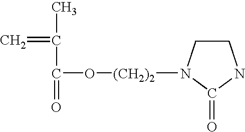

If the acrylic polymer is functionalized, it comprises, by weights from 0.5 to 15%, preferably from 1 to 10%, of monomers carrying acid, acid chloride, alcohol, anhydride or ureido functional groups.

The MVI (melt volume index) of the PMMA can be between 2 and 15 cm³/10 min, measured at 230° C. under a load of 3.8 kg.

As regards the UV stabilizer, this type of additive is known to a person skilled in the art and is disclosed, for example, in U.S. Pat. No. 5,256,472. Use is advantageously made of a benzotriazole, a benzophenone or a UV stabilizer of oxalic acid type. Use is also made rather of a UV stabilizer having a low volatility. Use may be made, as examples, of TINUVIN® 213 or 109 and preferably TINUVIN® 234 from Ciba Specialty Chemicals. Advantageously, the proportion of UV stabilizer in the adhesive layer is from 1 to 10% (that is to say, 1 to 10 parts of UV stabilizer per 100 parts of adhesive layer).

More specifically, mention may be made, as examples, of the following UV stabilizers: 2-[3,5-di-dimethylbenzyl)-2-hydroxyphenyl]benzotriazole, 2-[3,5 di(t-butyl)-2-hydroxyphenyl]benzotriazole, 2-(3-(t-butyl)-5-methyl-2-hydroxyphenyl)-5-chlorobenzotriazole, 2-(3,5-di(t-butyl)-2-hydroxyphenyl)-5-chloro-benzotriazole, 2-(3,5-di(t-amyl)-2-hydroxyphenyl)benzo-triazole, 2-ethoxy-2′-ethyl oxalic acid bisanilide, 2-ethoxy-5-(t-butyl)-2′-ethyl oxalic acid bisanilide, 2-hydroxy-4-(n-octoxy)benzophenone, bis(1,2,2,6,6-pentamethyl-4-piperidyl) sebacate, bis(1,2, 2,6,6-tetra-methyl-4-piperidyl) sebacate, dimethyl-2-(4-hydroxy-2,2,6,6-tetramethyl-1-piperidyl)ether or 1-[2-3-(3,5-di(t-butyl)-4-hydroxyphenyl)propionyloxy]-2,2,6,6-tetramethylpiperidine.

As regards the impact modifier, this term is used to denote acrylic elastomers based on at least one monomer chosen from acrylonitrile, alkyl (meth)acrylates and core-shell products. An additive of core-shell type is provided in the form of fine particles having an elastomeric core and at least one thermoplastic shell; the size of the particles is generally less than one μm and advantageously between 50 and 300 nm. Mention may be made, as examples of cores, of isoprene or butadiene homopolymers, copolymers of isoprene with at most 30 mol % of a vinyl monomer and copolymers of butadiene with at most 30 mol % of a vinyl monomer. The vinyl monomer can be styrene, an alkylstyrene, acrylonitrile or an alkyl (meth)acrylate. Another core family is composed of homopolymers of an alkyl (meth)acrylate and copolymers of an alkyl (meth)acrylate with at most 30 mol % of a monomer chosen from another alkyl (meth)acrylate and a vinyl monomer. The alkyl (meth)acrylate is advantageously butyl acrylate.

The vinyl monomer can be styrene, an alkylstyrene, acrylonitrile, butadiene or isoprene. The core of the core-shell copolymer can be crosslinked in all or part. It is sufficient to add at least difunctional monomers during the preparation of the core; these monomers can be chosen from poly(meth)acrylic esters of polyols, such as butylene di(meth)acrylate and trimethylol-propane trimethacrylate. Other difunctional monomers are, for example, divinylbenzene, trivinylbenzene, vinyl acrylate and vinyl methacrylate. The core can also be crosslinked by introducing therein, by grafting or as comonomer during the polymerization, unsaturated functional monomers, such as unsaturated carboxylic acid anhydrides, unsaturated carboxylic acids and unsaturated epoxides. Mention may be made, as examples, of maleic anhydride, (meth)acrylic acid and glycidyl methacrylate.

The shell or the shells are homopolymers of styrene, of an alkylstyrene or of methyl methacrylate or copolymers comprising at least 70 mol % of one of these above monomers and at least one comonomer chosen from the other above monomers, another alkyl (meth)acrylate, vinyl acetate and acrylonitrile. The shell can be functionalized by introducing therein, by grafting or as comonomer during the polymerization, unsaturated functional monomers, such as unsaturated carboxylic acid anhydrides, unsaturated carboxylic acids and unsaturated epoxides. Mention may be made, as examples, of maleic anhydride, (meth)acrylic acid and glycidyl methacrylate.

Mention may be made, as examples, of core-shell copolymers having a polystyrene shell and of core-shell copolymers having a PMMA shell. There also exists core-shell copolymers having two shells, one made of polystyrene and the other, on the outside, made of PMMA. Examples of impact modifiers and their process of preparation are disclosed in the following patents: U.S. Pat. No. 4,180,494, U.S. Pat. No. 3,808,180, U.S. Pat. No. 4,096,202, U.S. Pat. No. 4,260,693, U.S. Pat. No. 3,287,443, U.S. Pat. No. 3,657,391, U.S. Pat. No. 4,299,928, U.S. Pat. No. 3,985,704 or U.S. Pat. No. 5,773,520. Advantageously, the core represents, by weight, 70 to 90% of the core-shell copolymer and the shell 30 to 10%.

Mention may be made, as example of impact modifier, of that composed (i) of 75 to 80 parts of a core comprising, in moles, at least 93% of butadiene, 5% of styrene and 0.5 to 1% of divinylbenzene, and (ii) of 25 to 20 parts of two shells essentially of the same weight, one, internal, made of polystyrene and the other, external, made of PMMA.

Mention may be made, as other examples, of those having a core made of poly(butyl acrylate) or of copolymer of butyl acrylate and of butadiene and a shell made of PMMA.

All these impact modifiers of core-shell type are sometimes referred to as soft/hard because of the elastomeric core. There also exists other types of impact modifiers of core-shell type, such as hard/soft/hard products, that is to say that they have, in this order, a hard core, a soft shell and a hard shell. The hard parts can be composed of the polymers of the shell of the above soft/hard products and the soft parts can be composed of the polymers of the core of the above soft/hard products. Mention may be made, for example, of those composed, in this order:
of a core made of copolymer of methyl methacrylate and of ethyl acrylate,
of a shell made of copolymer of butyl acrylate and of styrene,
of a shell made of copolymer of methyl methacrylate and of ethyl acrylate.

There also exists other types of impact modifiers of core-shell type, such as hard (the core)/soft/semi-hard products. In comparison with the above products, the difference results from the “semi-hard” external shell, which is composed of two shells: one intermediate and the other external. The intermediate shell is a copolymer of methyl methacrylate, of styrene and of at least one monomer chosen from alkyl acrylates, butadiene and isoprene. The external shell is a PMMA homopolymer or copolymer. Mention may be made, for example, of those composed, in this order:
of a core made of copolymer of methyl methacrylate and of ethyl acrylate,
of a shell made of copolymer of butyl acrylate and of styrene,
of a shell made of copolymer of methyl methacrylate, of butyl acrylate and of styrene,
of a shell made of copolymer of methyl methacrylate and of ethyl acrylate.

Mention may be made, as example of preferred impact modifier of core-shell type, of DURASTRENGTH® 320 from ARKEMA.

The impact modifier improves the quality of the adhesion, bestows better mechanical behaviour on the film and provides for the flexibility of the adhesive layer.

As regards the surface layer, the latter comprises, by weight, from 70 to 100%, preferably from 90 to 100%, of a fluoropolymer and from 0 to 30%, preferably from 0 to 10% of an acrylic polymer. In order to provide for optimum protection, the surface layer is preferably composed only of fluoropolymer (100%) as a polymer, in particular only of a PVDF homo- or copolymer.

The surface layer exhibits a thickness of between 2 and 15 μm, preferably between 2 and 10 μm, more preferably still between 3 and 8 μm.

Surprisingly, despite the thinness of the surface layer, the protective function of the latter is maintained but makes it possible nevertheless to avoid the problem of trapping of the volatile compounds.

As regards the adhesive layer, the latter comprises, by weight, from 50 to 100% of an acrylic polymer, from 0 to 50% of a fluoropolymer, from 1 to 10% of a UV stabilizer and from 0 to 50% of an impact modifier.

Preferably, the adhesive layer does not comprise fluoropolymer, so as to maintain good thermomechanical behaviour. The adhesive layer comprises, in this case, by weight, from 50 to 100% of an acrylic polymer, from 1 to 10% of a UV stabilizer and from 0 to 50% of an impact modifier.

It is also possible to envisage not having impact modifier in the adhesive layer, in particular in order to avoid the phenomenon of whitening which sometimes occurs when an impact modifier is present. In this case, the adhesive layer comprises, by weight, from 90 to 99% of an acrylic polymer and from 1 to 10% of a UV stabilizer. The acrylic polymer then comprises, in this case, a content of comonomer(s) which is suitable for producing satisfactory flexibility, typically from 5 to 15% of at least one alkyl (meth)acrylate preferably chosen from methyl acrylate, ethyl (meth)acrylate, butyl (meth)acrylate and/or 2-ethylhexyl (meth)acrylate.

The adhesive layer exhibits a thickness of between 30 and 75 μm, preferably between 30 and 60 μm, more preferably still between 30 and 50 μm.

As regards the optional peelable protective layer, this is a temporary layer placed against the surface layer which makes it possible to protect the latter during the stages of handling the film and during its application to the substrate. This protective layer makes it possible to maintain or to promote a given surface condition. Thus, this layer can be smooth or rough depending upon the surface condition desired. This layer avoids the use of a mould-release agent which may damage the surface condition of the multilayer film. This layer exhibits, for example, a thickness of between 10 and 150 μm and preferably of 50 to 100 μm. The materials which can be used to prepare this layer can be chosen from: (i) saturated poly-esters, such as PET, PBT, copolyesters and poly-etheresters, (ii) polyolefin homopolymers or copolymers, such as polyethylenes and polypropylenes, (iii) polyamides or (iv) PVCs. Mention may be made, as example, of the PET sold under the Mylar® trade mark by DuPont. This layer can comprise various fillers, such as TiO₂, silica, kaolin, calcium carbonate, aluminium flakes and their derivatives. Use may also be made of a thick peelable layer, for example several mm or even up to 10 or 20 mm. In this case, it is not peelable in the literal sense but in the acting sense, that is to say that it does not adhere to the PVDF but that is serves as support.

The multilayer film can be produced by coextruding the adhesive layer, the surface layer optionally the protective layer. This technique makes it possible to get a good adhesion and contact between the layers.

As regards the substrate protected by the multilayer film according to the invention, the substrate can be a thermoplastic material or a thermoset material. It can also be a cellulose or lignocellulose material impregnated with an adhesive, in particular a sandwich panel.

The thermoplastic material can in particular be made of PVC or of ABS (Acrylonitrile-Butadiene-Styrene copolymer). It is more particularly PVC or ABS in the form of a profile impregnated with solvent, for example with trichloroacetate. A multilayer structure of the thermoplastic material/adhesive layer/surface layer type, in particular PVC impregnated with solvent/adhesive layer/surface layer type, is thus obtained.

The multilayer film is applied to the thermoplastic material according to techniques known to a person skilled in the art, for example by lamination or by hot compression moulding.

The thermoset material can result from the reaction of an unsaturated polyester with a reactive solvent, as taught in WO 03/035754 and JP 61057644. This type of material is used in all kinds of applications of daily life (switches, electric coffee makers, toasters, motor vehicle body components, and the like). Mention may be made, by way of examples, of the materials resulting from the radical copolymerization reaction between a reactive solvent, generally styrene, vinyltoluene or an acrylic monomer, and fumaric double bonds included in polyester prepolymers (which, for this reason, are referred to as unsaturated). The unsaturated polyester prepolymers result from a polyesterification between diacids or acid anhydrides and polyols. The radical copolymerization between the unsaturated prepolymer and the reactive solvent is initiated by a radical initiator (peroxide) or by a light/photoinitiator couple.

The thermoset material can also result from the reaction of a vinyl ester resin with a reactive solvent. The vinyl ester resin originates from the condensation of epoxide with an acrylic or methacrylic acid. It can also result from the reaction of a blend of polyester prepolymer and of a vinyl ester resin with a reactive solvent.

The thermoset materials based on unsaturated polyester or on vinyl ester resin are described in the encyclopaedia Ullmann's Encyclopaedia of Industrial Chemistry, publishers VCH, 5th edition, volume A21, pages 217-251.

A multilayer structure of the thermoset material/adhesive layer/surface layer type, in particular unsaturated polyester capable of releasing the reactive solvent/adhesive layer/surface layer type, is thus obtained.

The multilayer film is applied to the thermoset material according to techniques known to a person skilled in the art, for example by lamination or by hot compression moulding. It is also possible to employ the overmoulding technique. To do this, the multilayer film is placed in the mould, the surface layer being placed against the wall of the mould, then the precursor of the thermoset material is injected into the mould (that is to say, on the side of the adhesive layer) and, subsequently, crosslinking is brought about in order to produce a thermoset material coated with the multilayer film. The term “precursor” denotes the complete composition with the ingredients necessary for the crosslinking and the optional fillers, such as, for example, glass fibres or calcium carbonate.

If the mould is simple in shape, injection of the precursor of the thermoset material is sufficient to flatten the multilayer film against the wall of the mould; the film is then used as it was obtained. If the mould is more complicated in shape, it is sometimes necessary, to avoid stresses in the film and to provide good contact of the film with the walls of the mould, to preform the film by thermoforming before putting it in the mould. It is possible to use another mould of the same shape and the film is thermoformed using a component having the same, but positive, shape; it is also possible to use the same mould which serves for the injection of the substrate. It is also possible, for intermediate conditions of the above, not to carry out thermoforming but to put the film as is in the mould and, by compressed air on the side where the precursor of the thermoset material is injected, to flatten the film on the wall of the mould. It is also possible to apply a vacuum on the other side of the film in order to flatten it against the wall of the mould. Crosslinking is then brought about in order to produce a thermoset material covered with the multilayer film.

The multilayer film can also be used to cover a cellulose or lignocellulose material impregnated with an adhesive. A multilayer structure is thus obtained comprising, in order, a cellulose or lignocellulose material impregnated with an adhesive at its surface or throughout its body/the adhesive layer/the surface layer.

The cellulose or lignocellulose material can be wood, paper, preferably kraft paper, or board. It can also be wood chips or fibres which have been compacted in order to produce a more compact product forming a chipboard.

The adhesive can be a hot melt adhesive, for example based on ethylene-vinyl acetate (EVA) copolymer, based on polyamide or based on a poly-α-olefin. Adhesives of this type are capable of releasing volatile compounds, for example solvent or monomer residues.

It is preferably an adhesive obtained by the condensation of reactive compounds, such as urea, formaldehyde, a phenol or melamine. This type of adhesive is well suited to cellulose or lignocellulose materials (good adhesion and ease of application). It can thus be an adhesive of urea-formaldehyde (UF resin), melamine-formaldehyde (MF resin), phenol-formaldehyde (PF resin), melamine-urea-formaldehyde (MUF resin), melamine-urea-phenol-formaldehyde (MUPF resin) or phenol-formaldehyde-urea (of resol or novolac type, for example) type. A person skilled in the art involved in the application of adhesive to lignocellulose materials knows how to adjust the formulations for the manufacture of these adhesives according to the application targeted. Reference may be made for further details on adhesives of this type to Ullman's Encyclopaedia of Industrial Chemistry, 5th edition, volume A28, page 325, and volume A2, pages 116-141.

This type of adhesive is obtained by a more or less exhaustive polycondensation reaction (thus forming a condensate or a precondensate) which can be continued once impregnated on the cellulose or lignocellulose material. Adhesives of this type are capable of releasing water originating either from the polycondensation reaction itself or from the water used to dilute the formaldehyde. The adhesive can also be sold dispersed in water and applied in the dispersion form to the cellulose or lignocellulose material. In addition to the water, other volatile compounds, such as phenol, for example, can also be released from this type of adhesive.

The adhesive can be impregnated at the surface of the cellulose or lignocellulose material. For example, it can be a sheet of kraft paper covered on its surface with a layer of adhesive. The adhesive can also be impregnated-throughout the body of the cellulose or lignocellulose material, as is the case, for example, with a chipboard. The term “impregnation throughout the body” is understood to mean the fact of using the adhesive as binder for particles of cellulose or ligno-cellulose material. Thus, for example, a chipboard is manufactured by hot pressing a mass of wood chips, of wood fibres or of another lignocellulose material as a mixture with an adhesive, in particular a urea-formaldehyde or melamine-urea-formaldehyde adhesive. The pressing temperatures are generally from approximately 100 to 220° C. in order to obtain good adhesion of the chips for an acceptable manufacturing time employing high pressures of up to 150 kg/cm².

The multilayer film is applied to the cellulose or lignocellulose material impregnated with the adhesive at its surface or throughout its body. A multilayer structure is thus obtained comprising, in order, the cellulose or lignocellulose material/a layer of adhesive/the adhesive layer/the surface layer or else a multilayer structure is thus obtained comprising, in order, the cellulose or lignocellulose material impregnated with adhesive throughout its body/the adhesive layer/the surface layer. The adhesive and surface layers are those which were defined previously, including under all the alternative forms.

The various layers of the multilayer structure adhere to one another. It is not ruled out that a pattern or pigments be placed on the cellulose or lignocellulose material.

### Sandwich Panels

The multilayer film can be used to protect multilayer boards, commonly known as “sandwich panels”. Such panels are frequently used in the cladding of exterior or interior facades or else to produce floors.

A sandwich panel is obtained by stacking several layers of cellulose or lignocellulose material(s) (often paper and/or kraft paper) impregnated with adhesive. A coloured layer or a layer exhibiting a pattern (a decorative layer) may optionally be placed at the surface of the board.

The adhesive is preferably a thermosetting adhesive (UF, MF, PF, MUF, MUPF or phenol-formaldehyde-urea type). Preferably, it is a PF or MF type. An adhesive of resol type obtained by the reaction of a phenol with an aldehyde in an alkaline medium with a phenol/aldehyde molar ratio between 1:1 and 1:4 may also be used.

The sandwich panel is completed by subjecting it to high pressure (several tonnes), under hot conditions (120-160° C.), for a period of time of the order of 20-60 minutes (the reference is also to HPL (High Pressure Laminate) boards).

### Examples of Sandwich Panels

Examples of sandwich panels can be found in Applications EP 1 388 414 A1, EP 1 199 157 A1 or GB 2 307 882 A. Thus, Example 1 of Application EP 1 199 157 A1 describes a panel comprising, in order:
a layer made of phenolic kraft paper with a grammage of 180/290 g/m²;
a layer of adhesive;
a layer of wood;
a decorative layer composed of a tinted cellulose film and a cellulose film impregnated with melamine and having a silica filler.

Another sandwich panel example comprises, in order, a layer of paper, a layer of wood and optionally a decorative layer or else a layer of paper and a decorative layer. Another sandwich panel example comprises, in order, optionally a decorative layer, a layer of wood, a layer of paper, a layer of wood and optionally a decorative layer. Another sandwich panel example comprises, in order, a decorative layer, a layer of wood and a decorative layer. The multilayer film is applied to the layer of wood or to the decorative layer. The layer of paper can also be replaced by a stack of several layers of paper. Preferably, the paper used is kraft paper.

The decorative layer can be plain or can have a printed design. One or more film(s) of cellulose or printed paper may be concerned. A layer of thermosetting adhesive charged with pigments may also be concerned.

Examples of sandwich panels which are available commercially can also be given. The panel BAQ+® from Prodema is described on the Internet site of this company as being a high density panel composed of a core made of cellulose fibres impregnated with thermosetting phenolic resins and of a natural wood layer. The panel MAD® from Prodema is described as being a panel composed of a core made of plywood impregnated with thermosetting phenolic resins and of a layer of natural wood. The panel Parklex® 1000 from Gurea is described on the Internet site of this company as being a laminated panel made of wood at high density composed internally of fibres of wood or of paper which are treated with thermoset phenolic resins and which are very strongly compressed at high temperatures and of a layer of natural wood. The multilayer film is applied against the layer of wood.

A sandwich panel is thus available comprising, in order:

a base part made of kraft paper, which base part is impregnated with an adhesive/a layer of wood/the cellulose or lignocellulose material impregnated with the adhesive at its surface/the multilayer film, that is to say a base part made of kraft paper, which base part is impregnated with an adhesive/a layer of wood/the cellulose or lignocellulose material impregnated with the adhesive at its surface/an adhesive layer/a surface layer. Preferably, the cellulose or lignocellulose material is a sheet of kraft paper.

Another example of a sandwich panel, this time with a symmetrical structure, comprises, in order:

the multilayer film/the cellulose or lignocellulose material impregnated with the adhesive at its surface/a layer of wood/a base part made of kraft paper, which base part is impregnated with an adhesive/a layer of wood/the cellulose or lignocellulose material impregnated with the adhesive at its surface/the multilayer film, that is to say a surface layer/an adhesive layer/the cellulose or lignocellulose material impregnated with the adhesive at its surface/a layer of wood/a base part made of kraft paper, which base part is impregnated with an adhesive/a layer of wood/the cellulose or lignocellulose material impregnated with the adhesive at its surface/an adhesive layer/a surface layer.

In the case of a sandwich panel, the volatile compounds, which may be trapped by the multilayer film, can originate from the layer of adhesive. However, it is not ruled out that they may also originate from another of the layers and that they migrate to the surface (for example, from the base part made of kraft paper to the surface).

In the case of a cellulose or lignocellulose material, in particular in the case of a sandwich panel, the multilayer film is applied by hot compression moulding. Compression is carried out under a pressure generally of between 2 and 30 MPa and under hot conditions at a temperature generally of between 100 and 180° C.

### EXAMPLES

The PVDF used for the examples is a KYNAR® 740 from Arkema. The PMMA used is an OROGLAS® BS-8. It is a PMMA from ALTUGLAS INTERNATIONAL (formerly ATOGLAS) with an MVI of 4.5 cm³/10 min (230° C., 3.8 kg) in the bead form comprising a comonomer, methyl acrylate, at a level of 6% (by weight).

These examples illustrate the application of multilayer films to kraft paper impregnated with phenol-formaldehyde resin over its surface.

### Example 1

### According to the Invention

A 10-μm film of PVDF, itself coextruded over a blend of 90% (by weight) of PMMA and of 10% (by weight) of PVDF (40 μm), is prepared by film-bubble extrusion blowing. This film is subsequently cut into the form of a square with a side length of 300 mm. This film is placed on kraft paper (grammage 90 g/m²) coated with phenol-formaldehyde resin from CASCO. The structure is subsequently heated at 130° C. for 75 minutes under a pressure of 100 kg/m². The structure after removal from the mould exhibits good adhesion and an attractive surface appearance. The structure obtained is subsequently placed in an oven at 80° C. for 15 minutes and then an adhesion measurement is carried out at this same temperature. The adhesion is again measured to be very good. The surface appearance is good (no bubbles).

### Example 2

### Comparative

A 30-μm film of PVDF, itself coextruded over a blend of 90% (by weight) of PMMA and of 10% (by weight) of PVDF (40 μm), is prepared by film-bubble extrusion blowing. This film is subsequently cut into the form of a square with a side length of 300 mm. This film is placed on kraft paper (grammage 90 g/m²) coated with phenol-formaldehyde resin from CASCO. The structure is subsequently heated at 130° C. for 75 minutes under a pressure of 100 kg/m². The structure after removal from the mould exhibits good adhesion but exhibits a very large number of bubbles at the surface. The structure obtained is subsequently placed in an oven at 80° C. for 15 minutes and then an adhesion measurement is carried out at this same temperature. The adhesion is again measured to be very good. On the other hand, the surface appearance is not perfect; bubbles are present. This example shows that the thickness of the surface layer of 30 μm is not suitable.

### Example 3

### According to the Invention

A 5-μm film of PVDF, itself coextruded over a blend of 97% of PMMA and of 3% of TINUVIN® 234 (45 μm), is prepared by film-bubble extrusion blowing. This film is subsequently cut into the form of a square with a side length of 300 mm. This film is placed on kraft paper (grammage 90 g/m²) coated with phenol-formaldehyde resin from CASCO. The structure is subsequently heated at 130° C. for 75 minutes under a pressure of 100 kg/m². The structure after removal from the mould exhibits good adhesion and an attractive surface appearance. The structure obtained is subsequently placed in an oven at 80° C. for 15 minutes and then an adhesion measurement is carried out at this same temperature. The adhesion is again measured to be very good. The surface appearance is good (no bubbles).

### Example 4

### Comparative

A 10-μm film of PVDF, itself coextruded over a blend of 65% by weight of PMMA and of 35% by weight of PVDF (40 μm), is prepared by film-bubble extrusion blowing. This film is subsequently cut into the form of a square with a side length of 300 mm. This film is placed on kraft paper (grammage 90 g/m²) coated with phenol-formaldehyde resin from CASCO. The structure is subsequently heated at 130° C. for 75 minutes under a pressure of 100 kg/m². The structure after removal from the mould exhibits good adhesion and an attractive surface appearance. The structure obtained is subsequently placed in an oven at 80° C. for 15 minutes and then an adhesion measurement is carried out at this same temperature. The adhesion measured at this temperature is markedly poorer than that measured at 20° C.; the film can be peeled manually. The surface appearance is good (no bubbles).

This example shows that the thermomechanical behaviour is better when there is no PVDF in the adhesive layer.

TABLE I

| | | | | Adhesion |
|---|---|---|---|---|
| | Upper | Intermediate layer | Surface | of the |
| | layer | (% by weight) | appearance | film |
| Ex. 1 | PVDF | PMMA 90%/PVDF 10% | ++ | ++ |
| (Inv.) | (10 μm) | (40 μm) | | |
| Ex. 2 | PVDF | PMMA 90%/PVDF 10% | −− | ++ |
| (Comp.) | (30 μm) | (40 μm) | | |
| Ex. 3 | PVDF | PMMA 97%/Tinuvin 3% | ++ | ++ |
| (Inv.) | (5 μm) | (45 μm) | | |
| Ex. 4 | PVDF | PMMA 65%/PVDF 35% | ++ | −− |
| (Comp.) | (10 μm) | (40 μm) | | |

Similar results were obtained with the films applied on the sandwich panel of Example 1 of EP 1 199 157 A1 having the kraft paper of CASCO of examples 1-4.

1. A composition comprising a multilayer film directly attached to a substrate which gives off volatile compounds, wherein said multilayer film comprises:
a surface layer comprising, by weight, from 70 to 100%, of a fluoropolymer and from 0 to 30%, of an acrylic polymer;
an adhesive layer in direct contact with said substrate comprising from 50 to 100% of an acrylic polymer, from 0 to 50% of a fluoropolymer, from 1 to 10% of a UV stabilizer and from 0 to 50% of an impact modifier,
wherein the thickness of the surface layer is between 2 and 15 μm, and the thickness of the adhesive layer is between 30 and 75 μm.

2. (canceled)

3. The composition according to claim 2, wherein the adhesive layer comprises, by weight, from 90 to 99% of an acrylic polymer and from 1 to 10% of a UV stabilizer.

4. The composition according to claim 1, wherein the fluoropolymer is a polymer having, in its chain, at least one monomer chosen from compounds comprising a vinyl group capable of opening in order to polymerize and which comprises, directly attached to the vinyl group, at least one fluorine atom, one fluoroalkyl group or one fluoroalkoxy group.

5. The composition according to claim 1, wherein the fluoropolymer is chosen from:
vinylidene fluoride (VDF) homo- and copolymers preferably comprising at least 50% by weight of VDF, the comonomer being chosen from chlorotrifluoroethylene (CTFE), hexafluoropropylene (HFP), trifluoroethylene (VF₃) and tetrafluoroethylene (TFE),
trifluoroethylene (VF₃) homo- and copolymers,
copolymers, and in particular terpolymers, combining the residues of the chlorotrifluoroethylene (CTFE), tetrafluoroethylene (TFE), hexafluoropropylene (HFP) and/or ethylene units and optionally of the VDF and/or VF₃ units.

6. The composition according to claim 1, wherein the fluoropolymer is a PVDF comprising, by weight, at least 85% of PVDF.

7. The composition according to claim 1, wherein the acrylic polymer is a methyl methacrylate homo- or copolymer comprising at least 50% by weight of methyl methacrylate.

8. The composition according to claim 7, wherein the acrylic polymer comprises, by weight, from 5 to 20%, of at least one other alkyl (meth)acrylate.

9. The composition according to claim 8, wherein the alkyl (meth)acrylate is chosen from methyl acrylate, ethyl (meth)acrylate, butyl (meth)acrylate and/or 2-ethylhexyl (meth)acrylate.

10. The composition according to claim 1, wherein the acrylic polymer comprises monomers carrying acid, acid chloride, alcohol, anhydride or ureido functional groups.

11. The composition according to claim 10, wherein the acrylic polymer comprises, by weight, from 0.5 to 15%, of monomers carrying acid, acid chloride, alcohol, anhydride or ureido functional groups.

12. The composition according to claim 1, wherein the multilayer film further comprises a peelable protective layer placed against the surface layer.

13. The composition according to claim 12, wherein the peelable protective layer comprises: (i) saturated polyesters, such as PET, PBT, copolyesters and poly-etheresters, (ii) polyolefin homopolymers or copolymers, such as polyethylenes and polypropylenes, (iii) polyamides or (iv) PVCs.

14. The composition according to claim 1, wherein the substrate is a thermoplastic material.

15. The composition according to claim 14, wherein the thermoplastic material is PVC or ABS.

16. The composition according to claim 1, wherein the substrate is a thermoset material.

17. The composition according to claim 16, wherein the thermoset material results from the reaction of an unsaturated polyester or of a vinyl ester resin with a reactive solvent.

18. The composition according to claim 1, wherein the substrate is a cellulose or lignocellulose material impregnated with an adhesive.

19. The composition according to claim 18, wherein the cellulose or lignocellulose material is wood, paper or board or wood chips or fibres which have been compacted in order to produce a more compact product forming a chipboard.

20. The composition according to claim 1, wherein the substrate is a sandwich panel obtained by stacking several layers of cellulose or lignocellulose material(s) impregnated with adhesive.

21. The composition according to claim 1, wherein the adhesive is an adhesive of hot melt type.

22. The composition according to claim 1, wherein the adhesive is obtained by the condensation of reactive compounds.

23. The composition according to claim 1, wherein the adhesive is impregnated at the surface or throughout the body of the cellulose or lignocellulose material.

24. (canceled)

25. (canceled)

26. The composition of claim 1 comprising a multilayer film directly attached to a substrate which gives off volatile compounds, wherein said multiplayer film comprises:
a surface layer comprising, by weight, from 90 to 100%, of a fluoropolymer and from 0 to 10% of an acrylic polymer;
an adhesive layer in direct contact with said substrate comprising from 0 to 100% of an acrylic polymer, from 0 to 50% of a fluoropolymer, from 1 to 10% of a UV stabilizer and from 0 to 50% of an impact modifier,
wherein the thickness of the surface layer is between 3 and 8 μm, and the thickness of the adhesive layer is between 30 and 50 μm.
